(19) United States
(12) Patent Application Publication
(10) Pub. No.: US 2026/0167351 A1
(43) Pub. Date: Jun. 18, 2026

(54) DEVICE FOR EQUIPPING AND FITTING OUT FUSELAGE BARRELS

(71) Applicant: Airbus Operations GmbH, Hamburg (DE)

(72) Inventors: Sören Taube, Hamburg (DE); Benjamin Schulze, Hamburg (DE); Philip Koch, Hamburg (DE); Claudio Möller, Norderstedt (DE)

(73) Assignee: Airbus Operations GmbH, Hamburg (DE)

(21) Appl. No.: 19/396,751

(22) Filed: Nov. 21, 2025

(30) Foreign Application Priority Data
Nov. 25, 2024 (DE) 102024134714.7

(51) Int. Cl. B64F 5/10; B64F 5/50; B66F 9/00

(52) U.S. Cl. CPC B64F 5/10; B64F 5/50; B66F 9/00

(57) ABSTRACT

A device for equipping and fitting out fuselage barrels of an aircraft fuselage includes a support structure that carries an assembly platform, the assembly platform including at least one load support and including a frame and at least one actuator rail connected to the frame, wherein at least one actuator carriage can be movably arranged on each of the actuator rails, and wherein the load support is designed to be coupled to a support structure provided on the aircraft fuselage and/or a load introduction point in order to support the assembly platform relative to the aircraft fuselage.

### TECHNICAL FIELD

The disclosure herein relates to a device for the, preferably robot-assisted, equipping and fitting out of fuselage barrels of an aircraft fuselage. The disclosure herein also relates to an adapter piece for connecting the device to a fuselage barrel or an aircraft fuselage.

### BACKGROUND

The fuselage structure of a modern passenger or cargo aircraft usually consists of several sections arranged one behind the other in the longitudinal direction of the aircraft, which are substantially barrel-shaped and are connected to each other during the assembly of the aircraft. The front and rear sections are closed on one side, while the remaining sections are open on both sides and have a largely cylindrical outer contour. The barrel-shaped sections are also referred to as fuselage barrels.

Each fuselage barrel contains a load-bearing frame structure made of rigid stiffening elements, which may be made of light metal or a composite material. In addition, the fuselage barrels usually comprise several ring frames arranged one behind the other in the longitudinal direction of the aircraft, which are planked on the outside with the outer skin of the aircraft, and stringers extending in the longitudinal direction of the aircraft, which run between the ring frames and are connected to the outer skin of the aircraft.

Furthermore, aircraft are regularly divided into two or more decks. The lower deck, also referred to below as the underfloor area, typically contains a cargo hold. Above this are one or more decks, which may accommodate passenger compartments, for example. Adjacent floors are separated by a floor that is arranged on cross members connected to the frames at the sides. In addition, the floor is often supported by struts that are aligned in the vertical direction of the aircraft.

During the assembly of the aircraft, the individual fuselage barrels are put together. This involves, in particular, the assembly of numerous frame and stringer couplings, which connect the frames and stringers to each other or to the outer skin (typically by riveted joints). Any necessary surface treatments, such as the application of protective coatings, are then carried out and the floors are fitted with the specified equipment. In the case of the underfloor area, this includes, in particular, insulation materials, cables and cladding elements. In addition, the assembly of the sections involves a large number of work steps in which the structural elements of the sections and the outer skin are connected to each other: This usually requires riveted joints to be made between the elements of the adjacent sections and coupling elements and additional stiffeners to be attached. The subsequent work steps also comprise numerous individual work steps.

Conventionally, the aforementioned work steps are carried out manually by workers. However, their work is made considerably more difficult, particularly in the underfloor area, by the fact that the cross members and, in some cases, parts of the floor or any longitudinal members and the struts provided to support them are already in place when the work steps are carried out. This is because, for manufacturing reasons, these are assembled early on in the production process, in particular before the sections are joined together. The work steps must therefore be carried out by the workers in a very confined space (in particular, the height is very limited and, for example, in short-and medium-range aircraft, is regularly no more than 1.30 m). The work is therefore ergonomically very stressful for the workers.

It would therefore be desirable to automate the work steps in the underfloor area in particular. The challenges here are the limited installation space and the large number of different production steps that have to be carried out.

One approach is known from DE 10 2019 215 173. According to this, special holding devices are attached to the frames or other structural elements of the aircraft fuselage, each of which is designed to guide a movable carriage to which a robot arm can be attached for the automated execution of work. The holding devices and the carriage are arranged and designed in such a way that the carriage is supported by at least two or three holding devices in each process position.

The system known from DE 10 2019 215 173 can be used to carry out work during the manufacture of the aircraft. Afterwards, the holding devices can generally remain in the aircraft and be used to attach fixtures, such as for mounting an on-board kitchen or storage compartments. However, this is generally not possible if the system is used in the underfloor area, as there are usually no corresponding fixtures there and the retaining devices remaining in the aircraft would therefore unnecessarily increase the aircraft's weight.

### SUMMARY

The disclosure herein aims to enable improved automation of work steps on the decks of an aircraft, avoiding the disadvantages of known solutions.

According to a first aspect, the disclosure herein proposes a device for equipping and fitting out a fuselage barrel of an aircraft fuselage to solve this problem. The device comprises a support structure that carries an assembly platform, wherein the assembly platform comprises at least one load support and further comprises a frame and at least one actuator rail connected to the frame, on which at least one actuator carriage can be movably arranged. Actuators, e.g. robots, can be arranged on the actuator carriages to perform work on the fuselage drum. The load support is designed to be connected to a support structure provided in the fuselage to support the assembly platform relative to the fuselage. It can also be connected to a load introduction point on the fuselage, which is not necessarily part of the support structure. For example, such a load introduction point can be provided on an outer skin of the fuselage.

The device allows an assembly platform to be moved into the area of a fuselage barrel and the assembly platform to be supported at suitable points on the fuselage barrel using the load supports. The assembly platform is moved out of or into the support structure, for example, so that the overhang—i.e. the length by which the assembly platform protrudes from the support structure or into the fuselage—can be changed. The actuators of the assembly platform can then carry out work in the fuselage area. The load supports absorb rotational or tilting moments generated by the movement of the actuators, the actuator carriages and the actuator rails. The movable assembly platform has the advantage of allowing actuators arranged on the actuator carriages on the actuator rails to access the interior of fuselage barrels in order to carry out work there. In particular, the actuators can move without the need for base plates on which the actuators are moved. This allows the automation of a variety of tasks that previously had to be performed manually due to lack of accessibility.

In one embodiment, the load support is coupled to the support structure and/or a load introduction point of the fuselage barrel via an adapter piece. The adapter piece establishes a frictionally engaged connection between the fuselage barrel and the device and allows the load support to be connected to the support structure and/or the load introduction point even if these do not themselves have suitable connecting elements or counterparts for the load support. The adapter piece can be mounted on the support structure or the load transfer point of the fuselage barrel in order to transfer the force specifically to the mounting point in the structure of the fuselage barrel. In further embodiments, however, the load support can also be connected directly to the support structure or the load transfer point.

In one embodiment, the load support has a receptacle, and the receptacle of the load support has at least one tapered section for receiving a counterpart connected to the fuselage barrel. If the load support is connected to the support structure or load introduction point via the adapter piece, the counterpart may be a component of the adapter piece. In the case of a direct connection of the load support to the support structure or the load introduction point, the counterpart may be part of the support structure or the load introduction point. The counterpart of the adapter piece may, for example, be a cone and the receptacle of the load support a corresponding conical receptacle. This allows a frictionally engaged connection to be established between the adapter piece and thus also the fuselage barrel and the load support. The adapter piece can, for example, be an adapter plate, which preferably carries a cone that forms the counterpart for receiving the load support.

In one embodiment, the load support has a compensating element. The compensating element allows the load support to move in a horizontal direction, wherein horizontal means a direction perpendicular to the longitudinal axis of the load support. The compensating element may include an elastic component that allows horizontal movement. The compensating element may be elastic. The compensating element may also include a force measuring device. Movement in the horizontal plane allows for easy positioning because deviations from the exact position can be compensated for. Advantageously, the compensating element can compensate for deviations in the position of the receptacle of the load support and the counterpart of the adapter piece. This allows simplified lowering of the assembly platform and the load support onto the adapter piece, because even if the load support is initially in a horizontally deviating position, the deviation is compensated for by the compensating element.

In one embodiment, the support structure comprises a height-adjustable support system and the assembly platform is movably attached to the height-adjustable support system. The assembly platform is movable in such a way that the assembly platform can be moved in the direction of its longitudinal axis. In this way, the assembly platform can be positioned in the fuselage barrel with variable height and projection. The support structure may have more than one height-adjustable support system, in which case the support systems are arranged one above the other. The device then comprises two assembly platforms, which allow several actuators to work one above the other.

In one embodiment, the support structure comprises a lift system and the lift system comprises at least one vertically height-adjustable support module for holding objects, wherein the lift system is arranged on an outer side of the support structure, wherein the surface of this outer side is arranged parallel to the direction of movement of the assembly platform. The lift system allows auxiliary materials, e.g. materials and tools, to be transported from the floor to the height of the assembly platform. This allows the actuators to be supplied with auxiliary materials.

In one embodiment, two assembly platforms may be arranged one above the other in the support structure. The lift system may comprise two independent support modules so that one support module can be moved vertically independently of the other. For example, one support module may supply an assembly platform with auxiliary materials, or both support modules may supply both assembly platforms with auxiliary materials.

In one embodiment, the support structure comprises a base that contains a counterweight for the assembly platform. The counterweight stabilizes the assembly platform by balancing the tilting moment generated by the overhang of the assembly platform. The base can be movably arranged on rails or wheels/rollers.

In one embodiment, at least one auxiliary carriage is arranged on the actuator rail between the support structure and the actuator carriage. The auxiliary carriage can transport auxiliary materials, which are transported via the lift system, for example, to the actuators. The auxiliary carriage can have an actuator that transfers auxiliary materials from the lift system to the actuator carriage or the actuator. The auxiliary carriage may have a motor that moves the auxiliary carriage. For this purpose, a toothed rack may be provided on the actuator rail, which is connected to the motor of the auxiliary carriage via a corresponding gear wheel. The auxiliary carriage may therefore be designed as a self-propelled carriage.

In one embodiment of the device, the actuator rail is connected to the frame of the assembly platform via cross rails. This allows the actuator rail to be moved transversely to its own longitudinal axis or the longitudinal axis of the fuselage. For example, the ends of the actuator rails are movably connected to the short sides of the assembly platform by a cross rail, so that the actuator rail can move transversely to the longitudinal axis of the assembly platform and thus transversely to its own longitudinal axis and to the transverse axis of the fuselage barrel. This allows improved positioning of the actuators. The actuators require a shorter range, as there is less distance to bridge to the fuselage barrel. Several actuator rails can also be arranged next to each other so that a plurality of actuators can perform work in parallel or even collaboratively.

In one embodiment, the device has a mover or a drive unit that is set up to move the actuator carriage on the actuator rail. The mover may be a motor. The mover may be a rack and pinion drive. The toothed rack of the rack and pinion drive may be arranged on the actuator rail. The motor of the mover may be arranged on the actuator carriage. The actuator carriage may thus be self-propelled. The motor may have a gear wheel that meshes with the toothed rack arranged on the actuator rail.

In one embodiment, the actuator rail further comprises a guide rail which serves as a guide for the actuator carriage and/or the auxiliary carriage. The guide rail serves as a guide, i.e. the guide rail specifies the direction of movement of the carriage. For example, the carriage can only move parallel to the guide rail. Preferably, a corresponding guide element connected to the carriage can engage with the guide rail.

In one embodiment, the device has an extension with which at least one end of the assembly platform can be moved in its position relative to the support structure along the longitudinal axis of the assembly platform. Because the assembly platform is movable, the support structure can be moved directly or close to the opening of the fuselage barrel, for example on rails arranged transversely to the longitudinal axis of the fuselage barrel. After the support structure has been moved in front of the fuselage barrel, the assembly platform can be moved into the fuselage barrel. This configuration minimizes tilting moments and allows for a versatile system that can be moved or driven from one fuselage barrel to the next during production.

In one embodiment, the frame of the assembly platform is a telescopic frame. A telescopic frame allows the assembly frame to be extended from a retracted position into the fuselage. The structure is compact and can be easily moved when retracted without requiring much space along the path of movement.

In one embodiment, the support structure is arranged on rails that are aligned transversely to the longitudinal axis of the assembly platform. This allows the device to be moved back and forth between several fuselage barrels positioned parallel to each other transversely to the rails, so that the device can be used to assemble these fuselage barrels without having to move the fuselage barrels.

In one embodiment, the load support is variable in its vertical extension, wherein the load support in particular has a telescopic mechanism. This allows the height of the load support to be adjusted so that the height of the assembly platform can be changed. For example, the assembly platform can be used at the same support positions at different heights. For example, the height of the assembly platform can be changed when the assembly platform is already connected to the fuselage barrel.

Another aspect of the disclosure herein relates to an adapter piece that has a counterpart that can be picked up by the device according to the first aspect of the disclosure herein, and wherein the adapter piece is designed to be attached to a load-bearing point or support structure of a fuselage barrel. The load-bearing point may be a profile rail provided in the fuselage barrel. The adapter piece enables the device to be used in a variety of fuselage barrels, as it allows a frictionally engaged connection between the device and the fuselage barrel. Preferably, the adapter piece can be mounted by workers and removed again after the device has been used. This means that no additional requirements are placed on the fuselage barrel.

In a further aspect, the disclosure herein relates to a system comprising the device and the adapter piece. In one embodiment of the system and the device, the adapter piece is arranged in a fuselage barrel of an aircraft fuselage at load-bearing points and the device is connected to the device via a load support.

The disclosure herein therefore relates to a device for equipping and fitting out a fuselage barrel of an aircraft fuselage. The device comprises a support structure that carries an assembly platform, wherein the assembly platform comprises at least one load support and further comprises a frame and at least one actuator rail connected to the frame, on which at least one actuator carriage can be movably arranged.

The assembly platform can be movably arranged in the support structure and moved in a horizontal direction into the fuselage barrel. The frame of the assembly platform can be rigid. The frame of the assembly platform may be telescopic, i.e. the length of the assembly platform may be adjustable. In the case of a telescopic frame, the assembly platform may be firmly connected to the support structure. The assembly platform is then moved out of the support structure into the fuselage barrels. The assembly platform can be designed to be rollable. In this case, the frame can be designed as a push chain system in the longitudinal direction, i.e. in the direction in which the assembly platform is to be rolled out. Preferably, the chain links of the frame designed in this way can be rolled up in one direction and can absorb thrust loads in the longitudinal direction when rolled out. Furthermore, the chain links can preferably be designed so that they can only be rolled up in one direction in the longitudinal direction and cannot be moved out of the longitudinal direction in the other direction—i.e. they can absorb forces transverse to the chain direction. For example, the push chain can be designed so that when the chain is rolled out horizontally, the chain links can only move in one direction upwards from the horizontal position. This means that the chain can only be rolled up from the horizontal position in an upward direction. In the opposite downward direction, the chain links lock, so that the chain remains stretched in the horizontal direction and can absorb forces. If the frame of the assembly platform is designed to be rollable, the actuator rails are also rollable.

The assembly platform can be arranged within the support structure so that it is height-adjustable. This allows the assembly platform to be moved into the fuselage at different heights. For example, the assembly platform can be moved into the fuselage at the height of a passenger area or at the height of a cargo area. The load support can be connected in a frictionally engaged manner to airline rails, i.e. C-profiles with matching fittings. These profiles can distribute the load in the fuselage. Preferably, the load support can be connected to the profiles or a load-bearing point via an adapter piece.

The actuator rails can be arranged parallel to the longitudinal axis of the assembly platform within the frame of the assembly platform. The actuator rails can be movable parallel to the longitudinal axis of the frame of the assembly platform. One or more actuator carriages can be movably arranged on the actuator rails. The actuator rail may have one common guide rail or several separate guide rails for each carriage. If each carriage has its own guide rail and these are arranged next to each other, the carriages can be moved independently of each other and past each other in the longitudinal direction.

The load support can be connected directly to a support structure provided in the fuselage barrel. The support structure can be designed as a profile rail, for example as an airline rail. The support structure may also have one or more connection points or one or more suitable load transfer points, wherein “suitable” means that the force acting on the load transfer point does not cause damage to the fuselage. In a further embodiment, the load support may be connected to a load transfer point that is not part of a support structure. For example, the load support may be connected to a load transfer point located on the inside of the outer skin of the fuselage barrel and transfer force of the type into the fuselage barrel so that the fuselage barrel is not damaged. Preferably, the support structure may be a T-piece of an airline track. The load support may be connected to the profile rail via an adapter piece. In this case, the load support may have a receptacle for a counterpart of the adapter piece. The receptacle may be a receptacle for a cone and the counterpart may be a corresponding cone. The adapter piece can be connected to the profile rail as a matching counterpart to this profile rail. The adapter piece can be mounted by workers on profile rails that are present in the fuselage barrel. This allows the adapter piece to be positioned as freely as possible or the support structure for the assembly platform to be freely selected. This ensures that the assembly platform is supported at positions that can absorb the load caused by the assembly platform.

### BRIEF DESCRIPTION OF THE DRAWINGS

The aforementioned and other special features of the disclosure herein are also illustrated in the following description of example embodiments of the disclosure herein with reference to the figures, in which:

FIG. 1 shows a schematic and example representation of an aircraft fuselage with a device according to the disclosure herein in a sectional view;

FIG. 2a shows a schematic and example representation of a device with articulated arm robots arranged standing on the assembly platform, wherein the assembly platform is arranged in the underfloor area of the aircraft fuselage;

FIG. 2b shows a schematic and example representation of a device with articulated arm robots arranged suspended from the assembly platform, wherein the assembly platform is arranged in the underfloor area of the aircraft fuselage;

FIG. 3a shows a schematic and example representation of a device with articulated arm robots arranged in a standing position on the assembly platform, wherein the assembly platform is arranged on an upper deck of the aircraft fuselage;

FIG. 3b shows a schematic and example representation of a device with articulated arm robots that are suspended from the assembly platform, wherein the assembly platform is located on an upper deck of the aircraft fuselage;

FIG. 4 shows a schematic and example representation of the device arranged between the ends of two fuselage barrels;

FIG. 5 shows a schematic and example representation of the support structure of the device;

FIG. 6 shows a schematic representation of the assembly platform with the actuator rails and actuator carriages;

FIG. 7 shows a schematic representation of an actuator rail and one or two actuator carriages;

FIG. 8 shows the lift system, which is arranged on the outside of the support structure;

FIG. 9 shows a schematic representation of a load support for fastening in the forward direction in a fuselage barrel;

FIGS. 10a-d show schematic representations of a further embodiment of a load support for attachment in a fuselage barrel; and

FIGS. 11a-d show schematic representations of the connection mechanism of the load support with a T-piece, in particular a T-piece of an airline rail.

### DETAILED DESCRIPTION

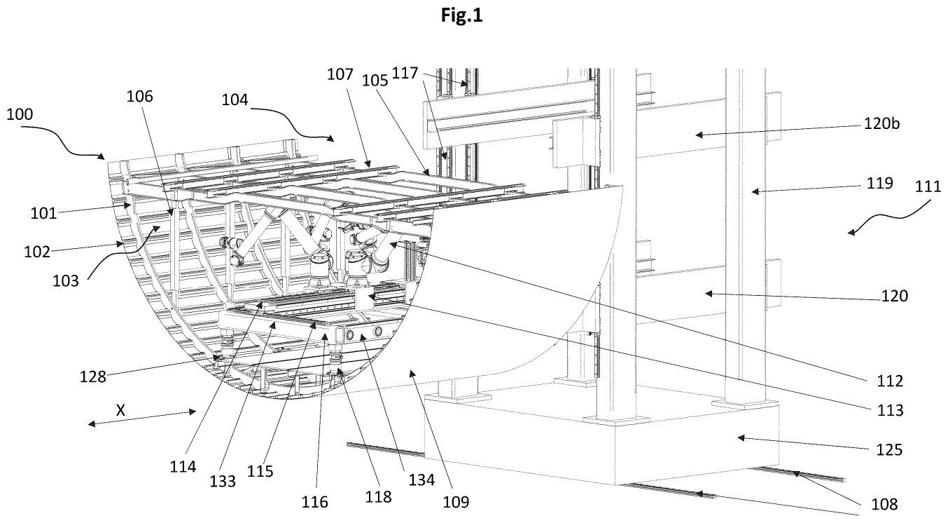

FIG. 1 shows, by way of example and schematically, a cross-section through a fuselage barrel 100 of an aircraft with a device according to the disclosure herein for equipping and furnishing fuselage barrels in a cross-section and in a perspective view. The aircraft may be a passenger or cargo aircraft.

The supporting structure of the fuselage barrel 100 comprises several ring frames 101, which are arranged one behind the other and parallel to each other in the longitudinal direction of the aircraft and are planked on the outside with the outer skin 109 of the aircraft. The ring frames 101 have recesses through which so-called stringers 102 extend, which are arranged continuously in the longitudinal direction of the aircraft. The stringers 102 and the ring frames 101 can be connected to each other by so-called clips. The stringers 102 reinforce the aircraft fuselage in its longitudinal direction. Together with the frames arranged perpendicular to them and the planking, they form the primary structure of the fuselage and mainly absorb tensile and compressive loads in their longitudinal direction. Depending on the aircraft type, the ring frames 101 may have a distance of between 50 cm and 100 cm, for example. The fuselage barrel also comprises an underfloor area 103. Above this are one or more additional floors. In the design shown, an upper deck 104 is provided, which in the case of a passenger aircraft, for example, can accommodate the passenger compartment in particular. A cargo hold can be set up in the underfloor area 103, for example.

The floor of the upper deck is supported by cross members 105, each of which extends within an associated ring girder 101 and is connected laterally to this ring girder 101, forming a supporting structure for the floor of the deck. The cross members 105 extend transversely to the longitudinal direction of the fuselage barrel 100. In the vertical direction—i.e., in the upward direction of the aircraft - the cross members 105 are each supported by struts 106. Furthermore, the supporting structure of the fuselage barrel may comprise several longitudinal beams 107, with the fuselage section shown in the figures having three longitudinal beams as an example. If present, the longitudinal beams 107 extend in the longitudinal direction of the aircraft and, together with the cross members 105, form a lattice-shaped supporting structure. The cross members 105 and the longitudinal beams 107 are arranged in a plane parallel to the floor.

The fuselage of the aircraft consists of a plurality of fuselage barrels 100, of which the supporting structure is basically designed in the same way and which comprise the aforementioned structural elements (ring frames 101, stringers 102, cross members 105, struts 106 and, where applicable, longitudinal members 107). The first and last fuselage barrels are closed on one side and generally taper towards their closed end. The remaining fuselage barrels 100 are open on both sides and have an approximately round or oval cross-section.

During assembly of the aircraft, the fuselage barrels 100 are connected to each other to form the fuselage of the aircraft. For this purpose, the open ends of the fuselage barrel 100 may be provided with known cross-bracing plates, which are fastened to connect the fuselage barrels to each other. The cross members 105 supported by the struts 106 and the longitudinal members 107 are already assembled in the individual fuselage sections when these are joined together.

One or more actuators 112, which may be robotic units, are provided for performing work in the area of a floor, for example the underfloor area 103. These may be designed in particular as articulated arm robots. The actuators 112 are arranged on an actuator carriage 113, which can be moved along an actuator rail 114. The actuator rail runs in the longitudinal direction of the aircraft. The actuator rail is connected to the frame 116 of an assembly platform via two cross rails 115. In the design shown, the frame is rectangular and may accordingly have two short cross members 133 and two longer longitudinal members 134, which form the sides of the rectangle. The cross rails 115 are arranged on the upper side of the short frame support of the assembly platform frame 129, i.e. on the side of the cross member 133 that is at the top in the vertical direction. The assembly platform 129 shown in FIG. 1 has a single actuator rail 114. However, more than one actuator rail 114 may also be connected to the assembly platform 129 via the cross rails 115. Each actuator rail 114 has at least one actuator carriage 113 on which at least one actuator 112 is arranged. As shown in FIG. 1, two or more actuators 112 may also be arranged on the actuator carriage 113. The actuator rails 114 can be moved on the cross rails 115 transversely to the longitudinal direction of the fuselage barrel 100. The actuators 112 can be moved by moving the actuator carriage 113 on and along the actuator rail 114 in the longitudinal direction of the actuator rail 114, i.e. in the longitudinal direction of the fuselage barrel. The actuator carriages can be self-propelled, i.e. they can have a drive that moves the actuator carriages on the actuator rail.

The frame 116 of the assembly platform has two load supports 118 at the end of the frame that protrudes into the fuselage barrel. The load supports 118 support the assembly platform 129 on the fuselage barrel 100. The other end of the frame 116 of the assembly platform 129 is connected to a support structure 111. The support structure 111 is the basic framework of the device in which the assembly platform 129 is movably arranged. The assembly platform 129, in particular the frame of the assembly platform, is connected to the support structure 111 via a height-adjustable support system 120. The support structure is cuboid in shape, with the edges of the cuboid preferably formed by beams. The frame 116 and, correspondingly, the assembly platform 129 can be arranged movably in the longitudinal direction X of the fuselage barrel in the height-adjustable support system 120. An extension may be provided on the frame 116 or on the height-adjustable support system, which moves the assembly platform 129 in the horizontal plane along the longitudinal axis of the assembly platform 129 relative to the support system 120. The assembly platform can be moved, for example, by a motor arranged on the height-adjustable support system. The motor can also be part of the assembly platform. In a further embodiment, which can be provided alternatively or additionally, the frame 116 and, accordingly, the actuator rail are telescopic, so that the frame 116 can be extended and retracted along its longitudinal axis. A telescopic frame can be used, for example, if the assembly platform is firmly connected to the height-adjustable support system. The assembly platform 129 can thus be moved from the support structure 111 into the fuselage. For this purpose, rollers 135 may be provided on the longitudinal beams 134, which run on rails 121 of the height-adjustable support system 120. The assembly platform 129 moves parallel to the ground and in the longitudinal direction of the fuselage barrel 100. One side of the support structure 111 is positioned in front of the opening of the fuselage barrel 100. This side of the support structure is perpendicular to the longitudinal direction X of the fuselage barrel. The assembly platform 129 is moved accordingly along the surface normal of the side of the support structure 111 facing the fuselage barrel 100. The frame 116 of the assembly platform 129 is connected to the height-adjustable support system 120 in such a way that the frame 116 can move in the height-adjustable support system 120 parallel to the ground in the longitudinal direction of the fuselage barrel 100. This allows the assembly platform to be moved in and out of the support structure 111 in order to move the assembly platform into the fuselage barrel arranged in front of the support structure. The support structure 111 can be arranged to be movable or mobile on rails 108 transversely to the longitudinal direction of the fuselage barrel. Accordingly, the rails 108 are preferably aligned transversely to the longitudinal axis of the assembly platform 129. In the event that the assembly platform 129 protrudes into the fuselage barrel and/or in the event that the assembly platform is moved, the support structure can be fixed in its movement on the rails 108. The support structure 111 can stand on a base 125 that is movable on the rails. The direction in which the support structure 111 is movable is thus perpendicular to the direction in which the assembly platform can be moved. Movement on the rails can be blocked.

The actuator 112 can thus be moved in the longitudinal and transverse directions of the fuselage barrel 100 and perform work at different locations along the fuselage barrel 100. The actuator rail 114 can extend along part of the longitudinal extent of a fuselage barrel 100 or through the entire fuselage barrel 100. It is also possible for the actuator rail 114 to run through several interconnected fuselage barrels. The fuselage barrels may also be only temporarily connected, in which case the actuator 112 performs the work steps necessary for permanent connection at the connection point.

The work performed by the actuator 112 in the manufacturing process may include, among other things, the following examples: riveting the sections at the transverse joint, setting frame and stringer couplings, applying protective paint and cap sealing, installing pipes, installing cladding elements, performing checks and automated material feeding.

In addition, an auxiliary carriage 122 can be arranged on each actuator rail 114 to supply the actuator 112 with material and consumables. The actuator carriage 113 can remain at the work site, while the auxiliary carriage 122 is moved along the actuator rail 114 in the direction of the support structure in order to be loaded with additional material or tools.

The support structure 111 consists of four vertical support structure frame beams 119. The height-adjustable support system 120, which supports the assembly platform 129, can be connected to the support structure frame beams 119 via rails 121 and/or a rack and pinion drive. The motor for driving the height-adjustable support system can be attached to the support structure. As described above, the frame 116 can be arranged in the height-adjustable support system 120 so that it can move in a direction parallel to the floor. Alternatively or additionally, the frame can be a telescopic frame in this direction. The longitudinal beams of the frame may therefore have a telescopic mechanism so that the length of the frame and thus the assembly platform 129 is adjustable. The length of the frame can therefore be adjusted. Accordingly, the actuator rails are also telescopic rails.

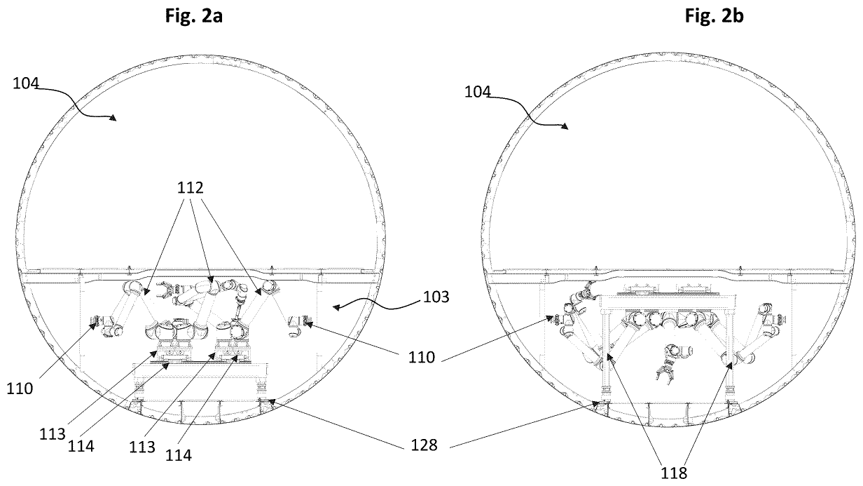

FIGS. 2a and 2b show a schematic cross-section through a fuselage barrel in which the assembly platform is arranged. The support structure 111 of the device is positioned in front of an open end of the fuselage barrel 100. The assembly platform is extended from the support structure 111 into a lower deck of the fuselage barrel 100. For applications in manufacturing, and in particular for the tasks described above, articulated arm robots have proven to be advantageous as actuators 112. Accordingly, in FIGS. 2a, 2b, as well as in all other embodiments shown, an articulated arm robot is attached to an actuator carriage 113 on an actuator rail 114. According to the disclosure herein, other actuators can be used. Articulated arm robots are characterized by great flexibility and a large reachable working space. In addition, it is common practice to equip articulated arm robots with different end effectors 110 in order to perform a variety of different tasks.

In the embodiment shown in FIGS. 2a, 2b, the articulated arm of the robot unit is connected to an end effector 110 on one side and has a connecting section on the other side. This is connected to an actuator carriage 113. The actuator carriage 113 is movably mounted along an actuator rail 114 and forms a carriage on which the robot arm can move through the fuselage barrel 100. The actuator 112 is arranged below or above the actuator rail 114 so that it protrudes into the underfloor area. The actuator carriage 113 can be attached to both the top and bottom of the actuator rail 114 may be movably arranged. The actuator carriage 113 may comprise the actuator rail 114 so that actuators 112 may be arranged above and below the actuator rail 114. The actuator carriage 113 may, for example, have a C-shaped profile that comprises the actuator rail 114 on one side.

The type of actuator rail 114 differs in the various embodiments. The actuator carriage 113 is adapted to the respective rail and enables low-friction and controlled movement of the actuator carriage 113 on the actuator rail 114. The actuator carriage 113 can be designed so that the actuator carriage 113 has a receptacle for an actuator above the actuator rail 114 or below the actuator rail 114. The receptacle can be a surface parallel to the floor on which the actuator 112 can be mounted. The actuators 112 can therefore be attached to the actuator carriage 113 in a suspended or upright position. The movement of the actuator carriages 113 and the corresponding movement of the actuators 112 can lead to a tilting moment acting on the device, in particular the assembly platform 129, for example due to the acceleration of the actuator carriages. The further the assembly platform 129 protrudes into the fuselage, the greater the resulting tilting moments. The load supports 118 support the assembly platform on adapter pieces 128. The adapter pieces 128 are connected to the fuselage. This stabilizes the assembly platform 129. The load supports have a receptacle 141 which is designed so that it can positively engage a counterpart 143 of the adapter piece 128. The receptacle and counterpart can form a plug connection. For example, this can be a cup-cone system consisting of a cone and a matching cup. The receptacle 141 may be tapered in sections. Because the receptacle tapers in at least one section, the receptacle 141 centers itself on the counterpart 143 of the adapter piece 128 when it is located in the tapered section and the receptacle is moved further towards the counterpart. For example, the counterpart of the adapter piece may be cone-shaped and the receptacle may be designed as a hollow cone. In this case, the receptacle 141 can be lowered onto the counterpart. If the receptacle is mounted so that it can move along axes that are perpendicular to the cone axis, the receptacle will center itself on the cone-shaped counterpart. The hollow cone can be designed so that it forms a conical connection with the cone-shaped counterpart.

The height of the load supports 118 connected to the fuselage barrel is adjusted to the height of the assembly platform 129, in particular to the height of the frame 116 of the assembly platform 129. The height of the assembly platform 129 relative to the support structure can be fixed or can be adjusted by the height-adjustable support system 120. The height of the load supports is adjusted so that the frame 116 of the assembly platform 129 is parallel to the floor, in particular also to the floor level of the underfloor area 103 and the upper deck 104 of the fuselage barrel 100. For this purpose, the load supports 118 can be height-adjustable by a telescopic mechanism. Alternatively, the height of the load support 118 can be selected according to the desired height of the assembly platform 129. In the embodiment shown in FIG. 2a, three parallel actuator rails 114 are shown, each with an actuator carriage and an actuator. The actuator carriages 113 can also carry a plurality of actuators. The actuator rails 114 are connected via two cross rails 115 to the sides of the frame 116, which form the ends of the frame 116 along the longitudinal axis of the fuselage barrel. The actuator rails 114 may have a movement unit that moves the actuator rails along the cross rails 115. The number of actuator rails 114 can be adapted to the fuselage barrel 100 or the task, so that one actuator rail or two or four actuator rails or a plurality of actuator rails are also possible. In further embodiments, several actuator carriages and correspondingly several actuators 112 may be movably arranged on an actuator rail along the actuator rail. FIG. 2a shows actuators 112 mounted in a standing position. FIG. 2b also shows an assembly platform 129 in the underfloor area of a fuselage barrel, with the actuators suspended from the actuator carriages. The actuator carriages may in particular have a receptacle for the actuators 112, which is arranged below and/or above the actuator rail 114. The assembly platform 129 may have two load supports 118 at its end facing away from the support structure 111. The load supports 118 may either be height-adjusted or height-adjustable. The height of the load supports 118 is adjusted parallel to the height of the assembly platform 129, which is adjusted via the height-adjustable support system. Preferably, the load supports 118 are telescopic, i.e. they have a telescopic mechanism that allows the height of the load supports 118 to be adjusted.

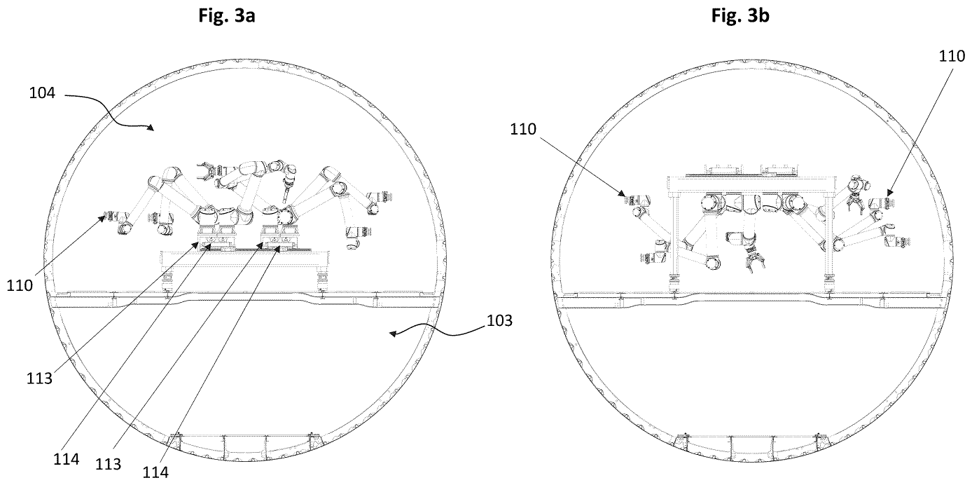

FIGS. 3a and 3b show a device analogous to FIGS. 2a, 2b, of which the assembly platform 129 protrudes into a level or deck 104 above the floor of a lower deck or lower level 103. In FIG. 3a, the actuators are mounted upright on the actuator carriages 113. The height of the assembly platform 129 is adjusted via the height of the load supports 118 so that there is sufficient space above the assembly platform for the actuators 112. The height of the assembly platform is adjusted by adjusting the height of the height-adjustable support system 120 and the load supports 118. In FIG. 3b, the actuators are suspended from the actuator carriages 113.

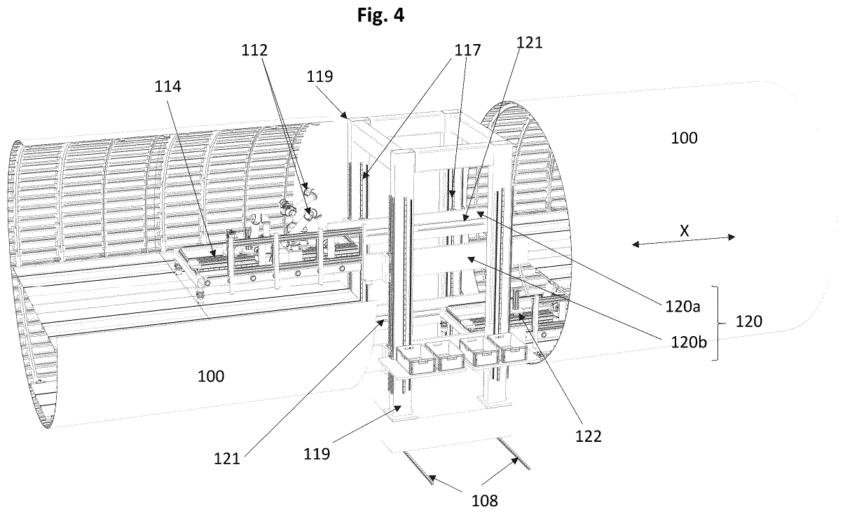

FIG. 4 shows the device for equipping and fitting out fuselage barrels between two fuselage barrels 100. The fuselage barrels 100 are arranged with their longitudinal axes on the same axis. The device is arranged between the fuselage barrels 100 on the common axis. The device can be moved to the assembly position between the openings of the fuselage barrels 100 via rails 108 that run transversely to the longitudinal axis of the fuselage barrels. The assembly platform 129 can be moved to the correct height relative to the fuselage barrel by a height-adjustable support system 120. The assembly platform 129 can be extended into the fuselage barrel 100 by an extension device. The assembly platform 129 can be arranged in a retracted position in an area within the height-adjustable support system 120 and within the vertical support structure frame beams 119 in such a way that the assembly platform protrudes on both sides of the support structure 111 in the longitudinal direction parallel to the longitudinal axis of the fuselage barrels 100. The assembly platform 129 remains movable in the height-adjustable support system 120 parallel to the longitudinal axis of the fuselage barrels 100. For example, in a retracted position, one end of the assembly platform 129 may be arranged on one side of the support structure 111 and the assembly platform 129 may protrude from the support structure 111 on the opposite side of the support structure.

In an extended position, as shown in FIG. 4, the assembly platform 129 is extended out of the height-adjustable support system 120. The height-adjustable support system 120 may have extension rails 121 through which the assembly platform 129, in particular the frame 116 of the assembly platform 129, can be extended out of the height-adjustable support system 120, and thus also out of the support structure 111, parallel to the ground in the longitudinal direction of the fuselage barrel. The height of the assembly platform 129 is adjusted by adjusting the height of the height-adjustable support system 120. The height-adjustable support system 120 can be adjusted in height using a height adjustor. The height adjustor can be, for example, a motor or a rack and pinion drive. The height-adjustable support system 120 can, for example, be adjusted in height using a motor mounted on the support structure 111.

In the device shown in FIG. 4, two height-adjustable support systems 120a and 120b, each with an assembly platform 129, are arranged one above the other in the frame of the support structure 111. The height-adjustable support systems 120 can be connected to the support structure via vertical rails 117 and can be adjusted in height by a motor. Each of the height-adjustable support systems 120 carries an assembly platform 129. The assembly platforms can be moved within the height-adjustable support system 120 along the longitudinal axis of the fuselage barrels parallel to the ground. Preferably, the assembly platforms are connected to the height-adjustable support system 120 via pull-out rails 121, wherein the pull-out rails 121 are aligned horizontally and parallel to the longitudinal direction of the fuselage barrels 100. FIG. 4 shows an upper assembly platform 129 which is moved out of the support system to the left in the figure so that it protrudes into the fuselage barrel on the left in the figure. A second assembly platform 129, which is connected to the lower height-adjustable support system 120, is moved out of the height-adjustable support system 120 so that this second assembly platform 129 protrudes into the fuselage barrel 100 shown on the right. The lower assembly platform 129 is arranged in the underfloor area 103, which forms a lower level, of the right-hand fuselage barrel 100, and the upper assembly platform is arranged on an upper deck 104, which forms an upper level, of the left-hand fuselage barrel 100. Both assembly platforms comprise two cross members 133 on which two actuator rails 114 are movably arranged transversely to the longitudinal direction X of the fuselage barrels 100. Two actuator carriages 113 are arranged on each of the actuator rails so that they can move in the longitudinal direction. An actuator 112, for example an articulated arm robot, is arranged on each actuator carriage 113.

FIG. 4 shows auxiliary carriages 122. The auxiliary carriages can correspond to the actuator carriages. The auxiliary carriages 122 are arranged so that they can move longitudinally on the actuator rails 114 towards the end of the assembly platform 129 furthest from the support structure, behind the actuator carriages. This configuration allows the auxiliary carriages to be moved back and forth between the actuator carriage 113 and the end of the assembly platform 129 facing the support structure 111. As shown in FIG. 4, even when extended, e.g. when the assembly platform protrudes into or beyond the fuselage, part of the assembly platform 129 is located inside the support structure 111 formed by the vertical support structure frame beams 119. At a position within the support structure 111, consumables or tools, for example end effectors for an articulated arm robot, can be loaded onto the auxiliary carriage 122. This can be done by a device provided on the support structure. The auxiliary carriage 122 may also comprise a device 123 for supplying the actuator. This device 123 may provide end effectors, for example tools, for the actuators. The device 123 can be a holder. If the auxiliary carriage is located near the actuator carriage, the actuator can remove the end effector from the holder. The actuator can transfer a previously used end effector to the holder and then pick up a new end effector from the holder. The auxiliary carriage can also carry auxiliary materials, such as material or additional tools, to the actuator carriage or actuator. An arm can be attached to the support structure frame support 119 for this purpose, which loads auxiliary materials onto the auxiliary carriage.

If the auxiliary carriage 122 is in a position directly behind the actuator carriage 113, the actuator can use consumables or tools from the auxiliary carriage. Similarly, the device 123 for loading the auxiliary carriage can pass consumables or tools on to the actuator. The device for loading the auxiliary carriage 122 may be an articulated arm robot. The device may have a structure for moving the auxiliary carriage 122, which can be arranged on the auxiliary carriage or on the assembly platform, and can comprise a belt drive or a spindle drive, or a rack and pinion drive. In the case of a rack and pinion drive, the motor may be arranged on the carriage.

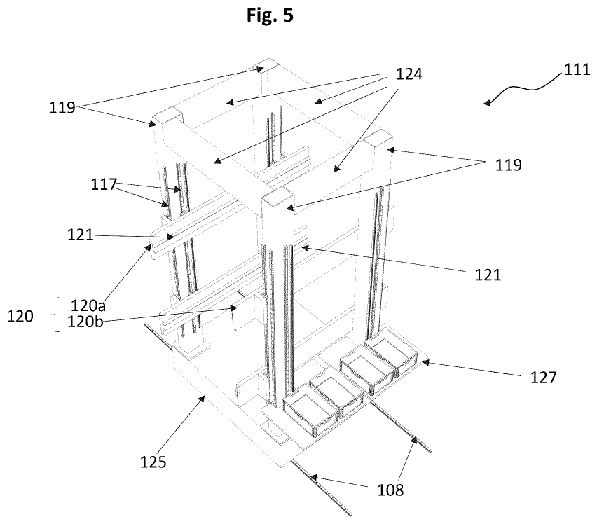

FIG. 5 shows the support structure 111 of the device for (robot-assisted) equipping and fitting out of fuselage barrels. The support structure 111 comprises four vertical support structure frame beams 119. At the upper end of the support structure 111, the four support structure frame beams 119 are connected by support structure cross members 124. The support structure frame beams 119 and the support structure cross members 124 are arranged orthogonally to each other. The support structure 111 is cuboid in shape, with the support structure frame beams 119 forming the four long edges of the cuboid and the support structure cross members 124 forming the four edges of one end face of the cuboid. In FIG. 5, the support structure cross members 124 form the upper end face of the support structure 111. The support structure frame beams 119 stand vertically on a base 125. The base 125 can be movably arranged on rails 108. The base can therefore have wheels that run on the rails 108 and connect the base 125 movably to the rails. The support structure frame beam 119 may have one or more vertical rails 117, by which the height-adjustable support system 120 is connected to the support structure 111 in a height-adjustable manner. A first support 120a of the height-adjustable support system 120 is arranged on vertical rails 117 on two adjacent support structure frame beams 119. A second support 120b of the height-adjustable support system 120 is arranged on pull-out rails 121 on the two opposite support structure frame beams 119. The support structure frame beams 119 are connected in pairs to one support 120a, b of the height-adjustable support system 120. The vertical rails 117, on which a support 120a, b is connected to the support structure in a height-adjustable manner, are arranged parallel and vertically.

The height-adjustable support system 120 is set up so that the two opposite supports 120a, b are at the same height. Each support has a rail 121 for movably receiving the assembly platform 129, via which the assembly platform 129 is connected to the supports 120a, b. Because the assembly platform 129 is connected to the two supports 120a, b of the height-adjustable support system 120 via the rails 121, the two supports 120a, b are at the same height. The rail 121 is located on an inner side of the support structure, i.e. the rail is arranged from the support structure frame beams 119 towards the center of the support structure 111, so that the rails 121 are connected to an assembly platform 129 arranged between the two beams 120a, b of the height-adjustable support system 120. The part of the support 120a, b that has the rail 121 is, as shown in FIG. 5, a flat element on which the rail 121 for moving the assembly platform 129 is arranged. In FIG. 5, two height-adjustable assembly platforms 129 may be arranged one above the other and connected to the support structure 111 via a corresponding height-adjustable support system.

A lift system 127 may be arranged on one outer side of the support structure 111. The lift system 127 is connected to two support structure frame beams 119, which also comprise the rails for height adjustment of one of the beams of the height-adjustable support system. The lift system is arranged on two support structure frame beams, which are also connected to a beam 120a, b of the height-adjustable support system. The lift system 127 is arranged on one side of the support structure 111 opposite one of the beams 120a, b. The two support structure frame beams 119 connected to the lift system are also connected to a beam 120a, b of the height-adjustable support system. A lift system 127 can have two parallel support modules. The support modules can be controlled separately from one another and allow several assembly platforms arranged one above the other to be supplied in parallel. For example, one support module 136 can supply one assembly platform 129 and another support module can supply the next assembly platform. Preferably, each support module 136 can supply each assembly platform.

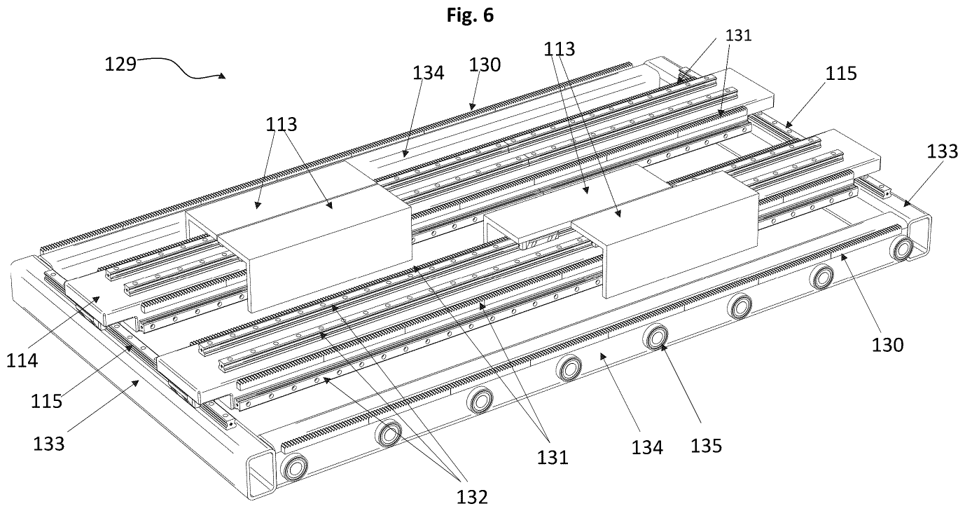

FIG. 6 shows the assembly platform 129. The assembly platform 129 is rectangular and comprises two cross members 133 and two longitudinal members 134, which form the edges of the rectangle. The cross rails 115 are arranged on the cross members 133. The cross rails 115 are arranged on a surface of the cross member 133, which is the upper surface of the cross member, i.e. the surface furthest from the ground. The assembly platform 129 also comprises two actuator rails 114, which are arranged transversely to the longitudinal axis X of the assembly platform and are movable on the cross rails 115. Two actuator carriages 113 are arranged on each actuator rail 114. The actuator carriages 113 can be connected to the actuator rails 114 via guide rails 132 of the actuator rails 114. One actuator carriage 113 can be arranged in the longitudinal direction X on one side of the actuator rail 114. Each side of the actuator rail 114 can have a guide rail 132, i.e. a vertical side of the actuator rail 114 can have a guide rail 132. The actuator rail 114 may have a guide rail 132 on its upper surface on each side, each for the actuator carriage 113 arranged on the respective side. The actuator rails 114 also have toothed racks 131 on each of their sides. The actuator carriages 113 are each connected to a toothed rack 131 via a rack drive. The toothed rack is arranged on the side of the actuator rail 114 on which the respective actuator carriage 113 is also arranged. The actuator carriages 113 shown in FIG. 6 can each carry an actuator 112 (not shown). Alternatively, one of the two actuator carriages 11 connected to an actuator rail 114 can carry an actuator 112, e.g. an articulated arm robot, and the other carriage, which is connected to the same actuator rail but on the other side in the longitudinal direction of the actuator rail 114, can serve as an auxiliary carriage 122 that can supply material and/or tools to the actuator 112. Toothed racks 130 and rollers 135 may also be arranged on the outside of the longitudinal beams 134 of the assembly platform 129 on the frame 116 of the assembly platform 129. A rack drive arranged in the support structure can move the assembly platform 129 out of the support structure or into the support structure via the toothed rack 130. The assembly platform 129 can roll on the rails 121 of the height-adjustable support system 120 with the rollers 135.

The actuators 112 can move with the actuator carriages 113 in the longitudinal direction X in the area of the frame 116 of the assembly platform 129. By moving the actuator rails 114 transversely on the cross rails 115, the carriages and thus also the actuators arranged on them move in the transverse direction Y, which is perpendicular to the longitudinal direction and, like the longitudinal direction, parallel to the floor.

The assembly platform 129 moves with the rollers 135 on the rails 121 of the height-adjustable support system 120 and can, for example, be moved into or out of the support structure via a rack and pinion drive. The drive motor can be attached to the support structure frame supports 119. Alternatively, the assembly platform can have a drive, for example a roller drive, which moves the assembly platform. Since the ends of the height-adjustable support system 120 and the ends of the rails 121 of the height-adjustable support system 120 are symmetrical in both directions relative to the longitudinal direction X, the assembly platform 129 can be moved in both directions relative to the longitudinal direction X.121 of the height-adjustable support system 120 are symmetrical in both directions relative to the longitudinal direction X, the assembly platform 129 can be moved in both directions in the longitudinal direction X out of the support structure and into the support structure 111.

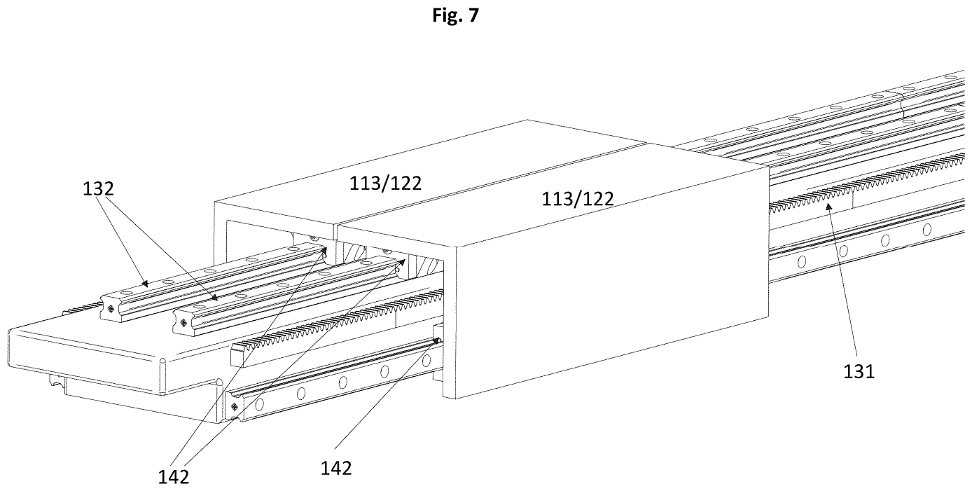

FIG. 7 shows an actuator rail 114 with two carriages 113, 122. The actuator rail 114 can consist of one or more T-or C-profiles. At least one T-profile or at least two C-profiles can have two parallel guide rails 132 pointing upwards in the vertical direction. These are suitable for serving as guides for the wheels 142 of the carriages 113, 122. At least one carriage can be arranged on each guide rail. The carriages are designed in such a way that a carriage connected to one upper guide rail can pass along the travel path of a carriage connected to the other upper guide rail. In other words, two carriages on the two adjacent guide rails can pass each other along the actuator rail 114. One carriage is arranged on one side of the actuator rail transversely to the longitudinal axis of the actuator rail, and the other carriage is arranged on the other side of the actuator rail 114 transversely to the longitudinal axis of the actuator rail 114. If the wheels 142 of the carriage 113, 122 are driven by a drive motor, in particular an electric motor, the carriage can move on the actuator rail 114 without an external drive. In another embodiment, the upward-facing surfaces serve as sliding surfaces on which the actuator carriage 113 or the auxiliary carriage 122 can rest and carriage along. In these embodiments, propulsion can be generated, for example, by wheels 142 pressed against the guide rail from below. The actuator rail 114 may have further guide rails 132 on its side surfaces, i.e. the vertical surfaces in the longitudinal direction X, which are also connected to the carriage. FIG. 7 shows two carriages 113, 122, each in the longitudinal direction X on one side of the actuator rail 114, which are each connected to a guide rail 132 on the side and a guide rail 132 on the upper surface of the actuator rail 114. The carriages 113, 122 can be moved separately from each other. The carriages 113, 122 can form a single carriage.

In another embodiment, the guide rail 132 may consist of a profile rail with a sliding coating. The sliding coating ensures low friction when moving on the rail.

The actuator rail may also have one or more toothed racks 131. The carriage may be connected to the respective toothed rack 131 on the side of the actuator rail on which the carriage 113, 122 is located via a rack drive. The guide rail 132 can be combined with a toothed rack of a rack drive, with the toothed rack being arranged at the top of the profile, i.e. on the side of the profile rail opposite the side connected to the actuator rail. The motor of the rack drive is arranged on the actuator carriage and moves the actuator carriage by being connected to the toothed rack via a gear wheel. In a further embodiment, the guide rail may consist of a combination of a profile rail and one or more round rods.

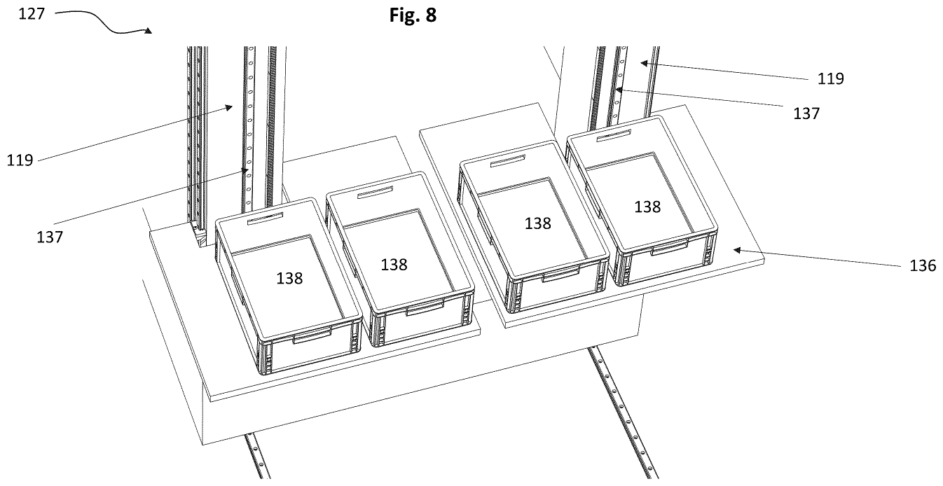

FIG. 8 shows the lift system 127, which can be arranged on one side of the support structure 111, which runs parallel to the direction of movement X of the assembly platform 129. Two lift systems can be provided on each side of the support structure 111 parallel to the longitudinal direction X of movement of the assembly platform 129. The lift system 127 may consist of two parallel support modules 136 for vertical transport. The support modules 136, which are arranged parallel to each other, i.e. in the longitudinal direction X, are moved vertically along the support structure frame beam 119. The support modules 136 can each be moved vertically via a rail 137 arranged on the outside of the support structure frame beam 119. The support module 136 can be used to raise and lower material or tools. The containers 138 can be moved onto the support modules 136 via a roller system. The containers, material or tools can be transferred to the auxiliary carriages. For example, the support module 136 can be moved to the height of the assembly platform 129 or the height-adjustable support system 120 and the containers 138 are transported to the auxiliary carriage 122. Similarly, containers or material can be transferred from the auxiliary carriage 122 to the support module 136, for example by moving the container 138 by rollers. Furthermore, an actuator can be provided which is arranged on the support structure frame beam 119 or the support module 136. The actuator can transfer auxiliary materials from the support module to an auxiliary carriage or actuator carriage. This allows for a paternoster-type transfer. One support module 136 can be raised with new material while the second support module moves containers 138 or material from the auxiliary carriage 122 downwards. During, before or after this, the other support module can move new material or tools, preferably in containers 138, upwards to the auxiliary carriage 122 and transfer them to the auxiliary carriage. A robot arm can be provided on the support structure or on the auxiliary carriage and transfers the container 138 and/or material/tool from the support module 136 to the auxiliary carriage or from the auxiliary carriage to a support module 136.

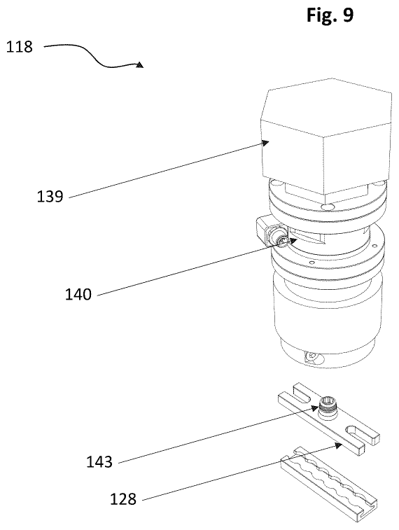

FIG. 9 shows a load support 118. The load support 118 connects the assembly platform 129 to the fuselage barrel 100 of an aircraft fuselage. The fuselage barrels 100 may only bear certain loads and must not be overloaded at specific points. During assembly, there are only a few elements within the fuselage barrel that can bear greater loads. For example, the load is transferred via connection points or load transfer points that are suitable for transferring the force into the fuselage without damaging it. For example, airline rails, which are specially designed profile rails, or specific T-pieces of these airline rails, to which an adapter piece 128 is attached, can be used. In the cargo area, the T-pieces can be mounted, for example, on the trusses that will later support the floor. In the passenger compartment, the seats are usually mounted on airline rails. These airline rails can be used during manufacture to mount the adapter pieces 128. The load support 118 is therefore designed so that it can be connected to an adapter piece 128 in a frictionally engaged manner. The adapter piece 128 serves as an adapter between the load support 118 and one of the (few) load-bearing points of the fuselage barrel 100. The adapter piece 128 can be mounted by workers at designated locations. For example, the adapter piece 128 can be connected to an airline rail present in the fuselage barrel. The adapter piece can also be connected to T-pieces located at the height of the base plate of the fuselage barrel. The adapter piece 128 has a counterpart to a receptacle 141 of the load support 118. The adapter piece 128 is connected to the load support 118 in a frictionally engaged manner by the receptacle 141 and the counterpart 143. The receptacle 141 can be, for example, a hollow cone and the counterpart a corresponding truncated cone. The counterpart can be a cone in order to create a frictionally engaged connection.

The load support 118 is connected at its upper end via a compensating element to the end of the assembly platform 129, which projects into the fuselage barrel. The load support 118 is connected in particular to the end of the assembly platform 129 that is furthest away from the support structure - in other words, the load support is connected to the end of the assembly platform 129 that faces away from the support structure 111. The load support 118 thus serves as a support for the projecting assembly platform 129 in the fuselage barrel 100. The load support 118 has a conical receptacle 141 at its lower end for the frictionally engaged reception of the truncated cone 143 of the adapter piece 128. The load support 118 can be placed by the height adjustment of the assembly platform 129 onto the counterpart of the adapter piece 128, for example a truncated cone 143. Alternatively or additionally, the load support may have a telescopic mechanism that adjusts the length of the load support vertically. The load support 118 is connected to the assembly platform via a compensating element 139.

The compensating element 139 allows the load support 118 to move in a plane parallel to the ground and thus parallel to the assembly platform 129. The compensating element 139 may have linear rails with which the load support is connected to the assembly platform 129 and which allow movement along these axes. Two linear axes can be arranged perpendicular to each other and parallel to the extension plane of the assembly platform 129. The compensating element can be designed to be elastic and allow movement along the plane parallel to the extension plane of the assembly platform 129 due to its elasticity.

The load support 118 may comprise a force measuring device 140. The force measuring device 140 measures the force exerted on the fuselage barrel via the adapter piece 128. The load measured by the force measuring device 140 can be compared with a tolerance limit. If the tolerance limit is exceeded, the operation of the actuators 112 and the assembly platform 129 is interrupted. For example, the carriages 113, 122 are moved in the direction of the support structure and/or the assembly platform 129 is moved out of the fuselage barrel in the direction of the support structure when the tolerance limit is exceeded. The force measuring device can determine the moment generated by the movement of the carriages and the forces applied to the fuselage barrel. The moments can be calculated from the lever arm resulting from the horizontal distance between the load support and the support structure. The force measuring device can be used to monitor the force applied to the fuselage barrel during the work. In particular, the movement of the carriages 113, 122, especially the starting and stopping, which exert an additional tilting moment and thus additional force on the fuselage barrel, can be stopped or interrupted if a tolerance limit is exceeded.

To connect the assembly platform 129 to the fuselage barrel, it is moved into the fuselage barrel by extending the assembly platform 129 out of the height-adjustable support system 120. The height of the assembly platform 129 is selected so that the load supports 118 are positioned above the truncated cone 143 of the adapter piece 128. The load supports 118 are positioned above the adapter piece and connected to the adapter piece 128 by lowering the assembly platform 129. The conical receptacle 141 of the load support accommodates the truncated cone 143 of the adapter piece 128.

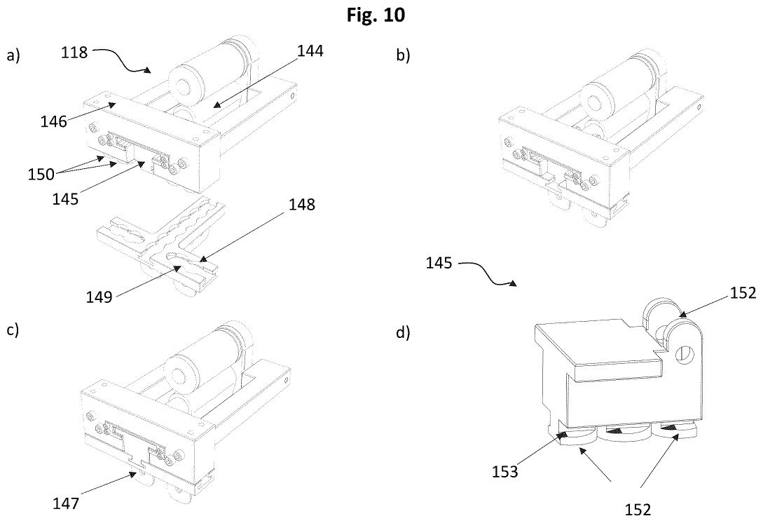

FIG. 10b shows a further embodiment of a load support. The load support 118 can be connected in a frictionally engaged manner to a T-piece 147 of a profile rail, for example an airline rail. Alternatively or additionally, the load support 118 can also be anchored to the profile rail. The load support 118 has a support element 146 in which a connecting element 145 is movably arranged. The load support further has a movement unit that moves the connecting element 145 in the support element.

The connecting element 145 may have a T-shaped profile, i.e. a T-shaped cross-section. The support element 146 may have a corresponding T-shaped recess in which the connecting element 145 is arranged so that it can be moved.

Airline rails or T-pieces of an airline rail are C-profile rails which have an elongated opening along their direction of extension, wherein the elongated opening additionally has round holes 148 at regular intervals. The elongated opening corresponds to the opening of the C of the profile. The opening of the C-profile thus has periodic holes 148. Between two holes 148, the opening 149 is straight.

The connecting element 145 has round feet 150 on an underside that faces the airline rail during operation, which fit through the holes 148. The round feet 150 have a plate that is undersized in relation to the diameter of the hole 148. The round feet 150 therefore fit just through the round hole 148. Above the plate, the foot 150 has a neck, the diameter of which is smaller than the straight part 149 of the elongated opening of the C-profile. This narrowest part is precisely the part of the elongated opening that does not have a hole 148. The foot 150 can therefore be inserted through a round opening in the C-profile and then moved in the longitudinal direction of the C-profile. The plate has a chamfer towards the neck. The chamfer is designed so that the outer edge of the plate has a height that allows the plate, when it is arranged in the C-profile, to be moved in the longitudinal direction of the C-profile from the position of the round opening, which has the form of a hole 148. This means that the height of the outer edge of the plate is less than the distance between the inside of the opening of the C-profile and the opposite inside of the C-profile.

Along the radius of the plate towards the inside, the chamfer and the plate are designed in such a way that the height of the plate increases. The height of the plate thus rises above the height of the distance between the inside of the opening of the C-profile and the opposite inside of the C-profile.

This configuration means that, after being inserted through the hole 148 in the C-profile, the foot can be moved along the longitudinal direction of the C-profile, creating a frictionally engaged connection between the foot 150 and the C-profile, as the foot is clamped in place by the increase in height of the plate during this movement.

The height can be selected so that movement of the foot 150 along the entire length of the airline rail is still possible with sufficient force.

The foot is now connected to a T-piece of an airline rail as follows: The support element 146 also has feet 151, which are arranged in such a way that the support element can be placed on the T-piece in a first direction. This means that the distance between the feet 151 corresponds to the distance between the holes 148 along the cross member of the T-piece, which is arranged in the first direction and on which the support element 146 is placed. After the support element 146 has been placed on top, the feet 151 are therefore arranged in the holes of the cross member of the T-piece of the airline rail. The movable connecting element 145 is arranged within the recess of the support element 146 in such a way that the feet 150 of the connecting element 145 face the holes in the vertical stem of the T-profile. This allows the load support 118 to be placed on the T-piece. The connecting element 145 is then moved in the recess of the support element 146 along the axis of the vertical stem of the T-piece. This causes the feet 150 of the connecting element 145 to move within the vertical stem out of the area of the holes 148. This causes the foot plate to be clamped within the C-profile. For example, the connecting element can be moved from a position in which the feet 150 are located at the positions of the holes 148 to a position in which the centers of the feet are located exactly between two holes 148. The maximum clamping force is achieved in this position. In other words, the movement of the feet 150 relative to the period with which the holes repeat corresponds to half a period.

In FIG. 10b, the connecting element 145 is in the first position, and in FIG. 10c, the connecting element 145 is in the second position. The movement of the connecting element 145 can be effected, for example, by a movement unit 144. The movement unit 144 can be, for example, electric or pneumatic.

FIG. 10d shows a detailed view of the connecting element 145. The connecting element 145 has a receptacle 152 with which the connecting element 145 can be connected to the movement unit 144. FIG. 10d also shows an alternative design of the foot plate, in which no circular chamfer is provided, but instead the height of the plate increases from the outside along a longitudinal direction, relative to the direction of movement of the connecting element 145, towards the center of the foot. This forms a guide chamfer 153. The plate can be designed so that the height, starting from the center of the plate in the direction of the longitudinal axis corresponding to the direction of movement of the connecting element 145, only changes or decreases in one direction. As a result, after the feet 150 have been positioned in the holes, the connecting element 145 must be moved in this direction—in which the height of the plate decreases—in order to establish the clamping. Movement in the other direction is not possible because the height of the plate in this direction is greater than the minimum distance between the opposite sides of the C-profile.

In this embodiment, the load support can therefore be placed on a T-piece of a profile rail, such as an airline rail, without an adapter piece.

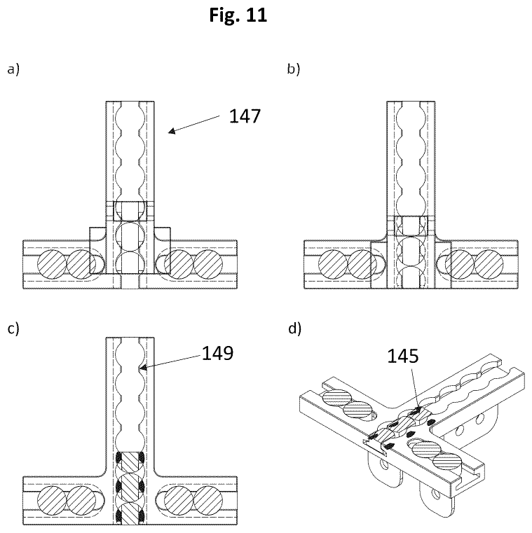

FIG. 11a-11d schematically show the frictionally engaged connection between the connecting element 145 and the profile of an airline rail. In FIG. 11a, the feet 150 of the connecting element are positioned in the holes of the profile. In FIG. 11b, the feet 150 have been moved by half a period relative to the periodicity of the arrangement of the holes in order to clamp the feet 150 under the profile. This is shown schematically in FIG. 11c, where the straight sections 149 of the opening of the C-profile clamp the plates of the feet 150 of the connecting element 145 in a frictionally engaged manner. The same configuration is shown in the view in FIG. 11d.

Additionally, it is noted that “comprising” or “including” does not exclude any other elements or steps and “a” or “an” does not exclude a multitude or plurality. It is further noted that features or steps which are described with reference to one of the above example embodiments may also be used in combination with other features or steps of other example embodiments described above. Reference signs in the claims are not to be construed as a limitation.

### LIST OF REFERENCE SIGNS

100 fuselage barrel
101 ring frame
102 stringer
103 underfloor area/lower deck/lower level
104 upper deck/upper level
105 cross member
106 struts
107 longitudinal beams
108 rails
109 outer skin
110 end effector
111 support structure
112 actuator
113 actuator carriage
114 actuator rail
115 cross rail
116 frame of the assembly platform
117 (vertical) rails of the height-adjustable support system
118 load support
119 (vertical) support structure frame beam
120a, b height-adjustable support system
121 extension rail or rail of the height-adjustable support system
122 auxiliary carriage
123 device for loading the auxiliary carriage
124 support frame cross member
125 base
127 lift system
128 adapter piece
129 assembly platform
130 toothed rack of the assembly platform
131 toothed racks of the actuator rails
132 guide rails of the actuator rails
133 cross beams of the assembly platform
134 longitudinal beams of the assembly platform
135 rollers
136 support modules of the lift system
137 rail
138 container
139 compensating element
140 force measuring device
141 receptacle
142 wheels
143 counterpart of the adapter piece
144 movement unit
145 connecting element
146 support element
147 T-piece
148 hole of the T-piece
149 straight opening of the T-piece
150 foot of the connecting element
151 foot of the support element
152 receptacle of the connecting element
153 guide chamfer

1. A device for equipping and fitting out at least one fuselage barrel of an aircraft fuselage, comprising:
a support structure that supports an assembly platform;
wherein the assembly platform comprises at least one load support and further comprises a frame and at least one actuator rail connected to the frame, wherein at least one actuator carriage can be movably arranged on each of the actuator rails,
and wherein the load support is configured to be connected to a support structure on the fuselage barrel and/or a load introduction point of the fuselage barrel in order to support the assembly platform relative to the fuselage barrel.

2. The device according to claim 1, wherein the load support is coupled to the support structure and/or a load introduction point of the fuselage barrel via an adapter piece.

3. The device according to claim 1, wherein the load support has a receptacle, and the receptacle of the load support has at least one tapered section for receiving a counterpart, wherein the counterpart is part of the adapter piece or part of the support structure or the load introduction point.

4. The device according to claim 1, wherein the load support has a compensating element and/or a force measuring device.

5. The device according to claim 1, wherein the support structure comprises a height-adjustable support system, and wherein the assembly platform is movably attached to the height-adjustable support system.

6. The device according to claim 1, wherein the support structure comprises a lift system, and wherein the lift system comprises at least one vertically height-adjustable support module, and wherein the lift system is on an outer side of the support structure, wherein the surface of the outer side is parallel to a direction of movement of the assembly platform.

7. The device according to claim 1, wherein at least one auxiliary carriage is on the actuator rail between the support structure and the actuator carriage.

8. The device according to claim 1, wherein the actuator rail is connected to the frame of the assembly platform via two cross rails.

9. The device according to claim 1, wherein the device has an extension with which at least one end of the assembly platform can be moved in its position relative to the support structure along an axis along a longitudinal axis of the assembly platform.

10. The device according to claim 1, wherein the frame of the assembly platform is a telescopic frame.

11. The device according to claim 1, wherein the load support is variable in vertical extension, wherein the load support comprises a telescopic mechanism.

12. An adapter piece comprising a counterpart that can be received by the receptacle of the device according to claim 3, wherein the adapter piece is configured to be attached to the load-bearing point or the support structure of the fuselage barrel.

13. A system comprising a device for equipping and fitting out at least one fuselage barrel of an aircraft fuselage, the device comprising:
a support structure that supports an assembly platform;
wherein the assembly platform comprises at least one load support and further comprises a frame and at least one actuator rail connected to the frame, wherein at least one actuator carriage can be movably arranged on each of the actuator rails,
wherein the load support is configured to be connected to a support structure on the fuselage barrel and/or a load introduction point of the fuselage barrel in order to support the assembly platform relative to the fuselage barrel, and
wherein the load support is coupled to the support structure and/or a load introduction point of the fuselage barrel via an adapter piece; and the system further comprising the adapter piece according to claim 12.

14. The system according to claim 13, wherein the adapter piece is disposed at load-bearing points in a fuselage barrel of an aircraft fuselage and is connected to the device via a load support of the device.
